(19) United States
(12) Patent Application Publication
(10) Pub. No.: US 2024/0270331 A1
(43) Pub. Date: Aug. 15, 2024

(54) COMPOSITE TRACK PAD

(71) Applicant: Caterpillar Inc., Peoria, IL (US)

(72) Inventors: Eric James Johannsen, Washington, IL (US); Mircea Dumitru, Washington, IL (US)

(73) Assignee: Caterpillar Inc., Peoria, IL (US)

(21) Appl. No.: 18/109,797

(22) Filed: Feb. 14, 2023

(51) Int. Cl. B62D 55/21; C22C 38/04

(52) U.S. Cl. CPC B62D 55/21; C22C 38/04

(57) ABSTRACT

Disclosed herein is an example track pad having a ground-contacting portion for use in a track-based machine to propel and support the machine across a supporting surface. The track pad may be a track pad that forms a link of a chain forming the track for the track-based machine. The track pad includes a cast body formed of a first alloy steel having a first strength and toughness. The track pad includes a pocket to receive an insert. The insert is formed of a second material comprising a work-hardening alloy such as manganese-steel. The insert is friction welded in place on the track pad and shaped and positioned to contact rollers of the track drive assembly and thereby reduce wear and fatigue on the track pad as a result of contact and force transferred through the roller.

### TECHNICAL FIELD

The present disclosure relates to composite tracks for track-type machines. More specifically, the present disclosure relates to tracks having a structural portion made of alloy steel and a wear surface made of manganese joined by friction welding to achieve improved wear life.

### BACKGROUND

Track-type machines are in widespread use in construction, mining, forestry, and other similar industries. The undercarriage of such track-type machines utilizes track assemblies, rather than wheels, to provide ground-engaging propulsion. Such track assemblies may be preferred in environments where creating sufficient traction is problematic, such as those frequently found in the industries identified above. Specifically, rather than rolling across a work surface on wheels, track-type machines utilize one or more track assemblies that include an endless loop of coupled track links defining outer surfaces, which support ground-engaging track shoes, and inner surfaces that travel about one or more rotatable track-engaging elements, such as, drive sprockets, idlers, tensioners, and rollers, for example.

Typical track chain assembly designs include a track pin either fixedly or rotatably connected to a pair of chain links and a bushing rotatably positioned between the links and about the track pin. Such track chain assemblies can operate in extremely adverse environments in which track joints may be exposed to various abrasive mixtures of water, dirt, sand, rock or other mineral or chemical elements. For heavy equipment, such as electric rope shovels and like, track pads that incorporate the track rail and track shoe in a single, unitary body are used.

The track chain assembly may include a plurality of crawler shoes connected end-to-end via pins to form an endless loop. The endless loop of crawler shoes may be wrapped around corresponding drive wheels, one or more idler wheels, and at least one roller. Drive wheels may engage pins (or engage bushings that encase pins), drive lugs, or other features of crawler shoes and thereby transmit torque from engine to track assemblies. Idler wheels and rollers may guide track assemblies in a general elliptical trajectory around drive wheels. A tensioner may be located between idler wheel and drive wheel to push these components apart and thereby maintain a desired tension of track assembly. Crawler shoes may function to transmit the torque from drive wheels as a driving linear (tractive) force into a ground surface. The weight of machine may be transmitted from drive wheel, idler wheel, and rollers through crawler shoes as a bearing force into the ground surface.

For example, U.S. Pat. No. 9,719,158 (the “'158 patent”) describes an explosively depth hardened crawler shoe. The explosively depth hardened crawler shoe includes a crawler show cast from manganese steel having at least one wear surface. The crawler shoe may be solution heat treated to form austenitic manganese steel. The crawler shoe is further produced by applying an explosive material to the wear surface and detonating the explosive material to harden the wear surface. However, due to the single composition of the crawler shoe, the wear surface and the remainder of the crawler shoe (e.g., track pad), are unable to have significantly different strength characteristics for surviving a harsh environment. Additionally, the crawler shoe may be limited in production as forming an entire crawler shoe (e.g., track pad) out of manganese steel may be difficult to shape, machine, and process due to the properties of manganese steel (such as limited machinability due to it's work-hardening properties). Accordingly, forming a crawler shoe of the manganese steel alloy may be difficult and expensive. interface between the drive wheel, idler wheel, and rollers described in the '158 patent can encounter high contact stresses which lead to galling failure of typical track pads. Additionally, the difficulty and expense of working with manganese steel alloys for the crawler shoe may result in significant additional production time and cost, as well as limitations on geometry due to the limited machinability of manganese steel. As a result, the track pad of the '158 patent, or other such track pads, may be additionally expensive, difficult to produce, time consuming to produce, and result in limited toughness for a ground-surface portion of the track pad that may further exacerbate track pad failures and increase downtimes. Furthermore, the difficulty of machining and/or servicing the manganese steel may result in added maintenance costs when the track pads are serviced.

Example embodiments of the present disclosure are directed toward overcoming the deficiencies described above.

### SUMMARY

In an example embodiment of the present disclosure, one general aspect includes a track system for track-based machinery. The track system includes an undercarriage supporting the track-based machinery, a sprocket coupled to the undercarriage and driven by a motor, an idle roller coupled to the undercarriage, and a set of track pads forming an endless loop around the sprocket and the idle roller, adjacent track pads coupled through bushings. An individual track pad of the set of track pads may include a body formed of alloy steel having a first surface configured to contact a supporting surface and an insert joined with the body at a location opposite the first surface, the insert formed of a work-hardening alloy different from the alloy steel and may include a roller contact surface configured to interface with the sprocket and the idle roller. In some implementations, the alloy steel may include a low carbon alloy steel. The alloy steel may include AISI 4320 steel. The track pad may include a drive lug positioned on the body, the drive lug configured to interface with the sprocket, and where the drive lug may include a second insert joined with the body at a wear surface of the drive lug, the second insert formed of the work-hardening alloy. The work-hardening alloy may include a manganese-steel alloy. Manganese may include at least 11% of the manganese-steel alloy. The manganese-steel alloy may include ASTM A128 steel. The first surface may include a second insert joined with the body, the second insert formed of a second alloy steel different from the alloy steel. The insert is friction welded with the body.

In another example embodiment of the present disclosure, a track pad for track-based machinery includes a body formed of alloy steel having a first side configured to contact a supporting surface and links adjacent opposite edges for joining to adjacent track pads in a track system. The pad also includes an insert joined with the body at a second side opposite the first side, the insert formed of a work-hardening alloy different from the alloy steel and may include a roller contact surface configured to interface with one or more rollers of the track-based machinery. Implementations may include one or more of the following features. The track pad may have a length dimension greater than 500 millimeters (mm) and a width dimension greater than 200 mm. The insert may have a thickness of greater than 50 mm. The work-hardening alloy may include an austenitic manganese-steel alloy. The austenitic manganese-steel alloy may include ASTM A128 steel. The alloy steel may include a low carbon alloy steel. The alloy steel may include AISI 4320 steel. The drive lug may include a second insert joined with the body at a wear surface of the drive lug, the second insert formed of the work-hardening alloy. The insert is friction welded with the body.

In yet another example embodiment of the present disclosure, a method for forming a track pad includes casting a body for the track pad using an alloy steel. The method also includes causing hardening of the body through a heat treatment and quench process. The method further includes shaping the body to form a receiving area. The method also includes casting a work-hardening alloy into a roller surface insert and joining, by friction welding, the roller surface insert and the receiving area of the body. The work-hardening alloy may include an austenitic manganese-steel alloy.

### BRIEF DESCRIPTION OF DRAWINGS

FIG. 1 is a perspective of a track chain assembly for a track-type machine, implementing the composite track pad, according to at least one example.

FIG. 2 is a perspective view of the composite track pad showing the wear surface and shoe portion before assembly, according to at least one example.

FIG. 3 is a perspective view of the composite track pad after assembly, according to at least one example.

FIG. 4 is sectional illustration of the composite track pad contacting a roller of the track chain assembly, according to at least one example.

FIG. 5 is another sectional illustration of the composite track pad contacting the roller of the track chain assembly, according to at least one example.

FIG. 6 is a flow diagram depicting an example method for forming the composite track pad described herein, according to at least one example.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts. Various embodiments of the present disclosure include a track chain member, such as a track pad, and a track chain that may use a plurality of track chain members according to various embodiments of the present disclosure, etc.

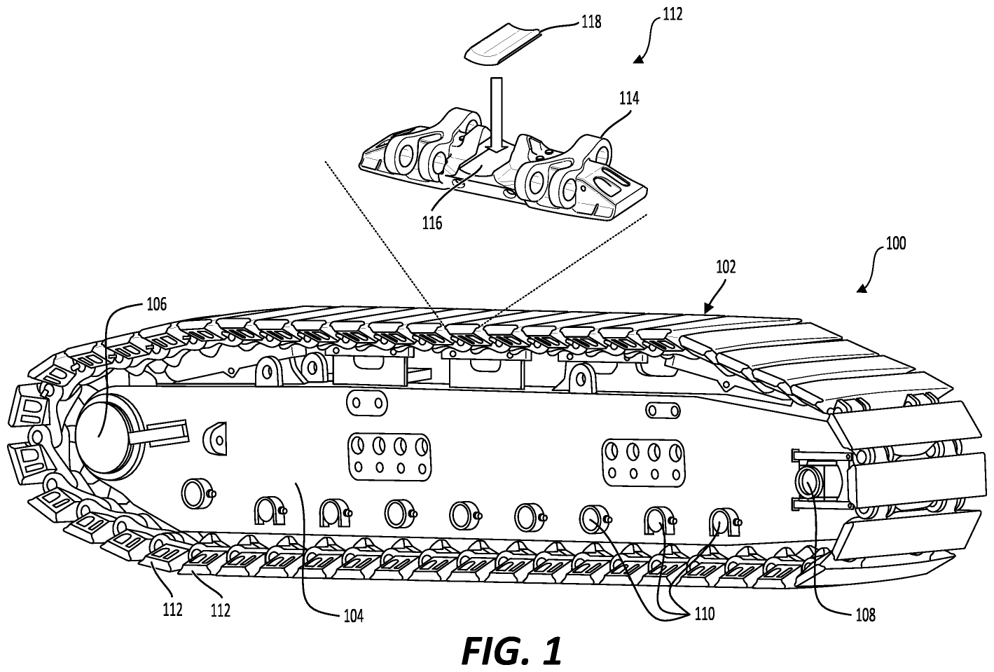

FIG. 1 is a perspective of a track chain assembly 100 for a track-type machine, implementing the composite track pad, according to at least one example. The track chain assembly 100 may be part of a track-type machine having an engine supported by a frame and configured to drive a tracked undercarriage. The track-type machine may be any machine that performs an operation associated with an industry such as mining, construction, farming, or another industry known in the art. For example, the track-type machine may be a material moving machine such as a front shovel, a rope shovel, a hydraulic excavator, a dozer, a loader, or another material moving machine.

The track chain assembly 100 includes an undercarriage frame 104 that supports a drive wheel 106, idler wheel 108, and rollers 110. The undercarriage frame 104 may include various components or elements for supporting different components of the track-type machine. The drive wheel 106 may be driven by an engine of the track-type machine to cause the track chain 102 to rotate around the undercarriage frame 104 to propel the track-type machine.

The track chain 102 is coupled with undercarriage frame 104 in a conventional manner. The track-type machine may include multiple track chains 102 for propelling the track-type machine. The track chain 102 includes a plurality of coupled together track pads 112 forming an endless loop extending about the drive wheel 106, idler wheel 108, and rollers 110, among other components. The rollers 110 are also mounted to the undercarriage frame 104 to support the track-type machine and guide track chain 102.

The unique design of track chain 102 and the overall track and undercarriage system of which they are a part are contemplated to enable the track-type machine to operate in certain environments such as soft underfoot conditions without becoming stuck. While use in the machine environment of an excavator or rope shovel is discussed herein, it should be understood that machine might comprise a different type of machine. For instance, track-type tractors or even half-track machines are contemplated herein. Further still, the machine might employ a conveyor or other type of machine wherein tracks are used for purposes other than as ground engaging elements. Also, the machine might be some type of hydraulic shovel, bulldozer, excavator, backhoe, etc.

The track pads 112 include a body 114 formed of an alloy steel forming the primary structural portion of the track pad 112. The body 114 includes contact surfaces for riding on a support surface and bushing contact surfaces for linking together the track pads 112 into the track chain 102. The body 114 also includes a pocket 116 for receiving an insert 118. The insert may be formed of a different material, such as a work-hardening material that enables it to wear against the rollers 110 and other elements of the undercarriage frame 104 without fatiguing or cracking the body 114. The body 114 and the insert 118 may be joined by friction welding to take advantage of the differences in characteristics between the different materials.

In some aspects, the track pads 112 may be sized such that particular forming processes are not available. For example, the dimensions of the track pad 112 may exceed 800 mm to 3600 mm in length by 300 mm to 600 mm in width by 250 mm to 400 mm in thickness thereby making forming through forge pressing unavailable due to size constraints of forge presses. Additionally, effective heat treatment and processing to a particular hardness and/or through annealing may be difficult due to the size of the track pads 112, which may retain a large amount of thermal heat during processing and therefore be difficult to quench and achieve hardness and toughness levels required for withstanding the forces experienced by the track pads 112 during use.

Accordingly, the track pads 112 may be formed of a material having sufficient toughness for surviving a harsh environment, such as mining, while also being able to withstand the forces applied through the track pad assembly to support the weight of the track-type machine. For example, the body 114 may be formed of a hardenable steel having high toughness and shock resistance. In some examples, the body 114 may be formed of a low-carbon alloy steel. In some examples, the body 114 may be formed of AISI 4320 alloy steel.

Meanwhile, the insert 118 may be formed of a material that has high resistance to wear and abrasion, including high impact strength, tensile strength, and yield strength. In some aspects, a manganese-steel may be used for the insert, such as an alloy of steel having 10% or more manganese contained therein. In some examples, the alloy may have between 12-14% manganese steel. The insert 118 may be formed of an austenitic manganese-steel alloy in some examples. In some aspects, ASTM A128 steel may be used for the insert 118. The manganese-steel alloy for the insert 118 work-hardens rapidly upon being placed in use without an increase in brittleness, thereby providing greater wear and abrasion resistance against the rollers of the track assembly than the body 114.

In some examples, the insert 118 may have a length dimension in a range of 450 mm to 650 mm (or more or less in some examples), a width dimension in a range of 200 mm to 350 mm (or more or less in some examples), and a thickness dimension in a range of 75 mm to 150 mm (or more or less in some examples). In some instances, the thickness may compress by 10 mm or more during use, resulting in work-hardening of the insert 118.

In some aspects, at least part of the present disclosure relates to the formation, production, and/or manufacture of the track pad 112 and the components and systems in which the track pad is used, such as the track chain assembly 100 and/or track-type machine.

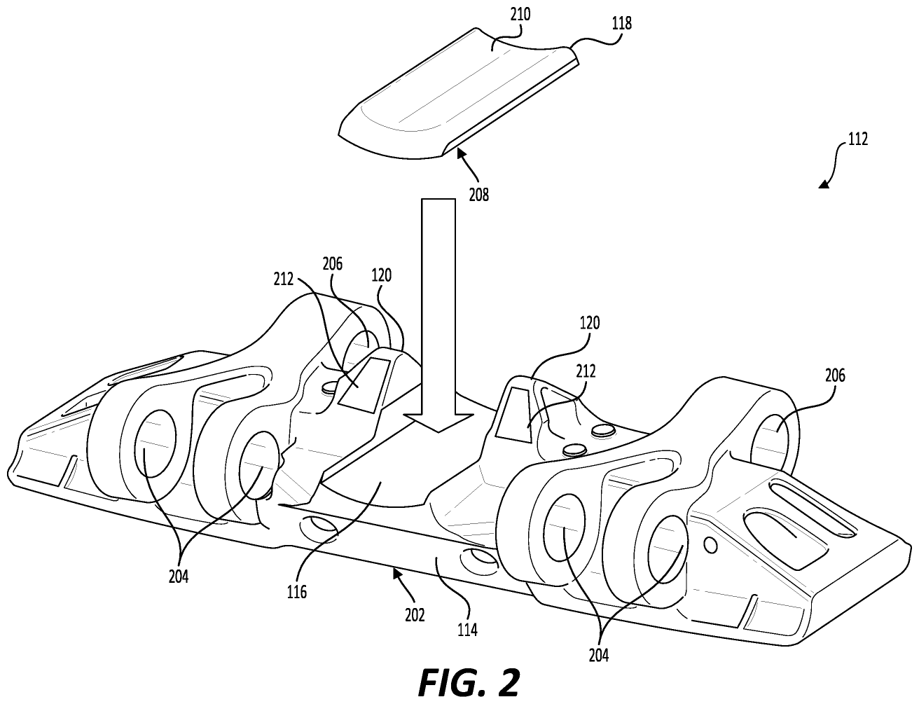

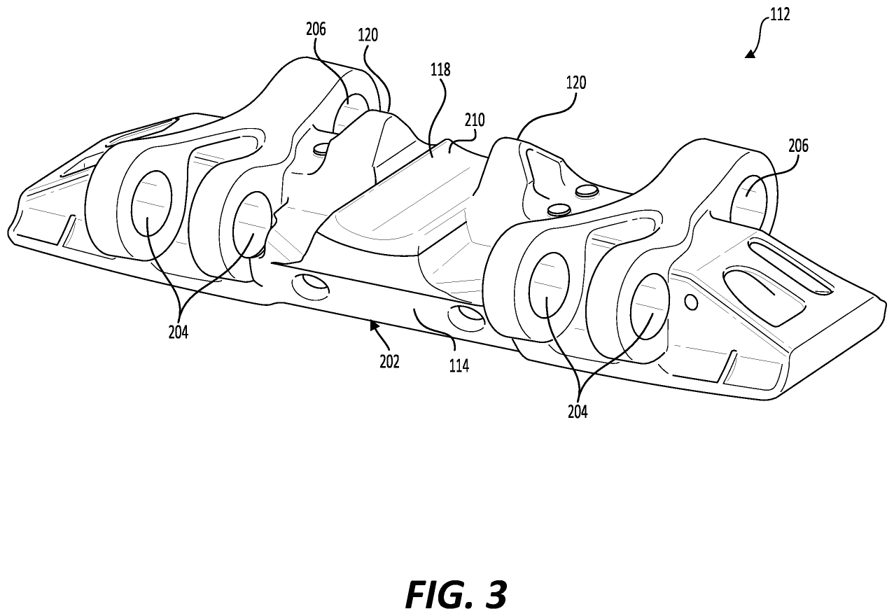

FIG. 2 is a perspective view of the composite track pad showing the wear surface and shoe portion before assembly, according to at least one example. The track pad 112 is shown with the insert 118 before joining together, while in FIG. 3, the track pad 112 is shown with the insert 118 joined to the body 114. The track pad 112 of the present disclosure may be applicable to any track-type mobile machine. However, the disclosed track pads 112 may be particularly applicable to larger machines, in which the forces passing through the track assembly are significant and can affect longevity of the track pads 112. This may be particularly important for expensive machines that operate around the clock, where downtime and the price of replacement track pads 112 are costly to the owner.

FIG. 2 shows an exemplary track pad 112 that may include one or more pairs of links 204 and 206 that are generally parallel with each other. Each link 204 and 206 may include at least one pin bore formed at an end thereof for connecting to links of other track pads 112, thereby forming a chain. Track pad 112 may include a ground-engaging surface 202. The ground-engaging surface 202 may be disposed at a bottom side of the body 114. In this example, the ground-engaging surface 202 and links 204 and 206 are integrally formed as a single cast and/or forged component. In other embodiments, links 204 and 206 and ground-engaging surface 202, as well as other components described herein may be formed separately and joined by any suitable process known in the art, such as by welding and/or using threaded fasteners, if desired. Ground-engaging surface 202 may have any external geometry known in the art. For example, ground-engaging surface 202 may be generally plate-like, include transverse ridges or grousers, have openings, and/or include any other features common in the art.

The body 114 includes a roller path 210 disposed on top side of insert 118. Roller path 210 may be disposed between links 204 and 206 when the insert 118 is assembled with the body 114. The insert 118 may have a interface surface 208 that contacts a pocket 116 of the body 114 where the pocket 116 and the interface surface 208 are used to permanently join the insert 118 and the body 114, for example through friction welding. The roller path 210 may define a surface for guiding a roller of the drive assembly across the track pad 112. The roller path 210 may include a wear surface that engages with the roller. The weight of the track-type machine may be transmitted from the roller through the roller path 210. Over time, the force applied by the roller to the roller path 210, and the corresponding insert 118, may cause plastic deformation of the insert and associated work hardening at the insert 118.

The roller path 210 may be planar, arcuate, or have any suitable shape for engaging the roller. For example, the roller may have a curvature, and the roller path 210 may be shaped with a similar curvature. When the machine is in motion, additional rolling and sliding forces between the roller path 210 and the roller create friction wearing of the roller path 210. Abrasive debris such as gravel, dirt, sand, or other ground material may lodge between the roller and the roller path 210 and cause additional wearing and/or grinding of roller path 210.

Accordingly, the material used to form the insert 118 is resistant against friction and abrasion. The insert 118 may be formed of a material that has high resistance to wear and abrasion, including high impact strength, tensile strength, and yield strength. In some aspects, a manganese-steel may be used for the insert, such as an alloy of steel having 10% or more manganese contained therein. In some examples, the alloy may have between 12-14% manganese steel. In some aspects, ASTM A128 steel may be used for the insert 118. The manganese-steel alloy for the insert 118 work-hardens rapidly upon being placed in use without an increase in brittleness, thereby providing greater wear and abrasion resistance against the rollers of the track assembly than the body 114. In some examples, other work-hardening alloys and materials may be used to form the insert 118, including stainless steels and other steel alloys with work-hardening properties similar to manganese-steel.

To withstand the bearing forces without cracking or breaking, the insert 118 may be formed of a metal having high strength, such as manganese steel. Manganese steel may be cast to produce the insert 118 of any suitable shape and dimensions, but may be brittle after casting. Thus, the insert 118 may be solution treated to achieve austenitic grain structure in the metal, which improves overall toughness. Before casting, chromium may be added to the manganese steel to promote faster work hardening of the austenitic manganese steel. Because austenitic manganese steel is also soft, insert 118 may experience plastic deformation near roller path 210 during use. Instead of performing expensive and time-consuming heat treatment processes to harden the entire body 114, work hardening of the insert 118 may provide the required hardness for the roller path 210 to withstand the forces experienced during use.

In the example of FIG. 2 and FIG. 3, track pad 112 includes a pair of drive lugs 120 disposed on the top side of the body 114 that engage drive wheels in the track assembly. Drive lugs 120 may be disposed between links 204 and 206 on either side of the roller path 210 and/or the pocket 116 to receive the insert 118. In other embodiments, drive lugs 120 may be positioned at other locations on the track pad 112, and fewer or more drive lugs 120 may be included. Drive lugs 120 may contact openings, pockets, or teeth of drive wheels in the track assembly to receive torque from the engine and provide tractive force to the track pad 112 for moving the machine. Drive lugs 120 may have one or more wear surfaces that contact drive wheels. When the machine is in motion, these wear surfaces may experience grinding and wearing from the forces transmitted by drive wheels, which can be magnified when abrasive debris become lodged between drive lugs 120 and the drive wheels. Accordingly, in some examples, additional inserts 212, similar to insert 118, may be incorporated within the drive lugs 120.

The drive lugs 120 may be partially and/or entirely formed of a material that has high resistance to wear and abrasion, including high impact strength, tensile strength, and yield strength. In some aspects, a manganese-steel may be used for the drive lugs 120, such as an alloy of steel having 10% or more manganese contained therein. In some examples, the alloy may have between 12-14% manganese steel. In some aspects, ASTM A128 steel may be used for the drive lugs. The manganese-steel alloy for the drive lugs work-hardens rapidly upon being placed in use without an increase in brittleness, thereby providing greater wear and abrasion resistance against the sprockets of the track assembly than the body 114. In some examples, other work-hardening alloys and materials may be used to form the drive lugs, including stainless steels and other steel alloys with work-hardening properties similar to manganese-steel.

To withstand the bearing forces without cracking or breaking, the drive lugs may be formed of a metal having high strength, such as manganese steel. Manganese steel may be cast to produce the drive lugs 120 of any suitable shape and dimensions, but may be brittle after casting. Thus, the drive lugs 120 may be solution treated to achieve austenitic grain structure in the metal, which improves overall toughness. Before casting, chromium may be added to the manganese steel to promote faster work hardening of the austenitic manganese steel. Because austenitic manganese steel is also soft, drive lugs 120 may experience plastic deformation during use. Instead of performing expensive and time-consuming heat treatment processes to harden the entire body 114, work hardening of the drive lugs 120 may provide the required hardness to withstand the forces experienced during use. The drive lugs 120 and/or inserts of the drive lugs 120 may be formed and friction welded or otherwise joined to the body 114.

As illustrated in FIG. 3, after the insert 118 is joined with the body 114, the track pad 112 is a single component that may be used to build the track chain. In some examples, additional surfaces of the track pad 112 may receive inserts, such as the drive lugs 120 described above and the ground-engaging surface 202, which may receive an insert similar to insert 118 to provide increased hardness at the surface of the track pad 112 that engages with the ground.

For example, in some instances, a high-carbon alloy steel may be used for the ground-engaging surface 202 to provide greater hardness. In some examples, a low-carbon alloy steel may be used that has a greater toughness than the body 114. In some examples, the ground-engaging surface 202 may be heat treated to have a greater hardness than the body 114, thereby improving wear and abrasion resistance against the ground. In some examples, the manganese-steel alloy described herein or other work-hardening alloys may be used for the ground-engaging surface 202 and may be friction welded to the body 114.

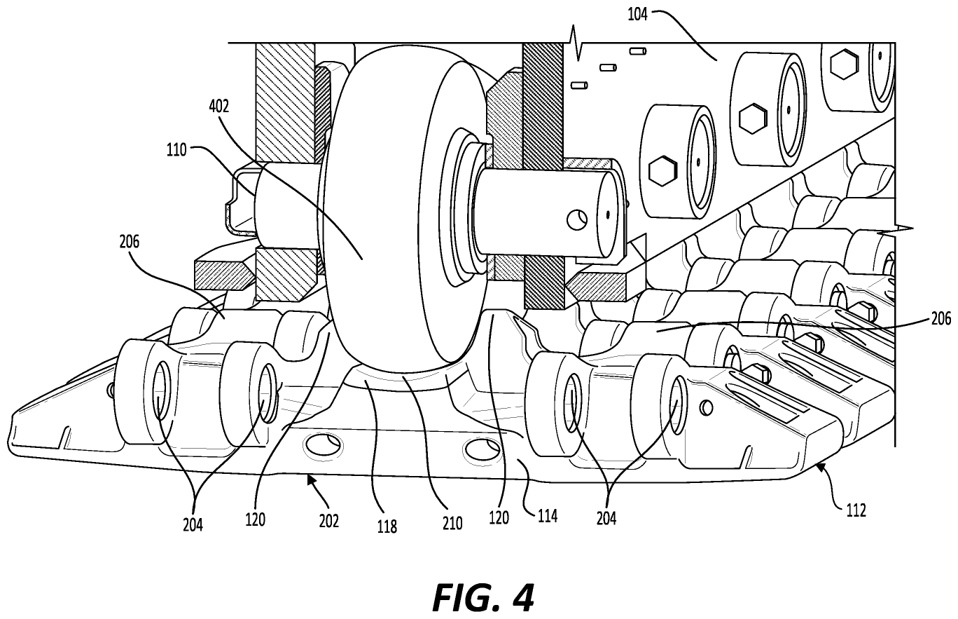

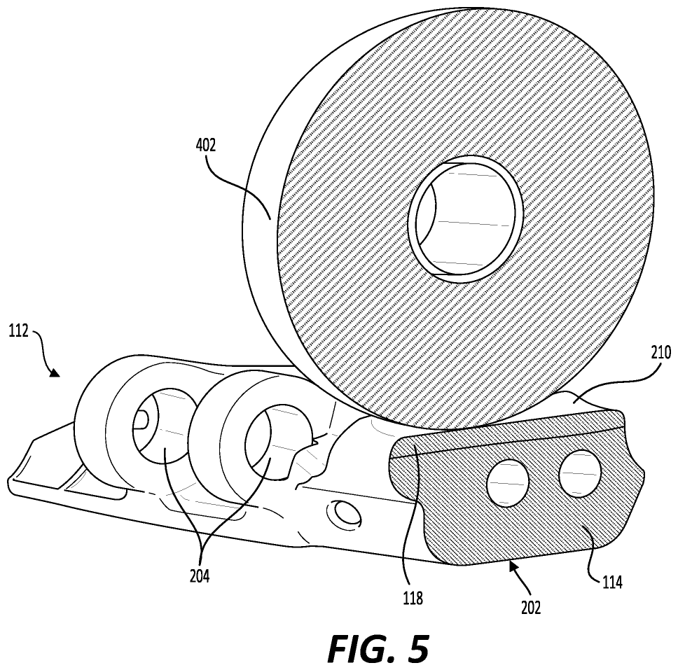

FIGS. 4 and 5 provide sectional illustrations of the track pad 112 contacting a roller 110 of the track chain assembly 100, according to at least one example. The roller 110 includes a roller surface 402 that contacts the roller path 210 of the insert 118. The roller 110 is coupled to the undercarriage frame 104 that supports the weight of the track-type machine. Accordingly, the roller 110, and therefore the roller surface 402, transmits force to the insert 118 and the track pad 112 to support the track-type machine. During use, when the insert 118 is formed of a work-hardening alloy such as manganese-steel, the insert 118 may compress during initial use as plastic deformation occurs, resulting in the work-hardening of the roller path 210 to resist friction and abrasion wearing of the insert 118.

The internal structure of the track pad 112, may have varying geometry, including passages, columns, holes, protrusions, and various other shapes and configurations. In some examples the track pad 112 has a solid body. In some examples, such as illustrated in FIG. 5, the track pad 112 may include various internal geometry. The track pad 112, and more specifically the body 114 is dimensioned and configured to provide structural support to the track pad 112 and thereby support the track-type machine.

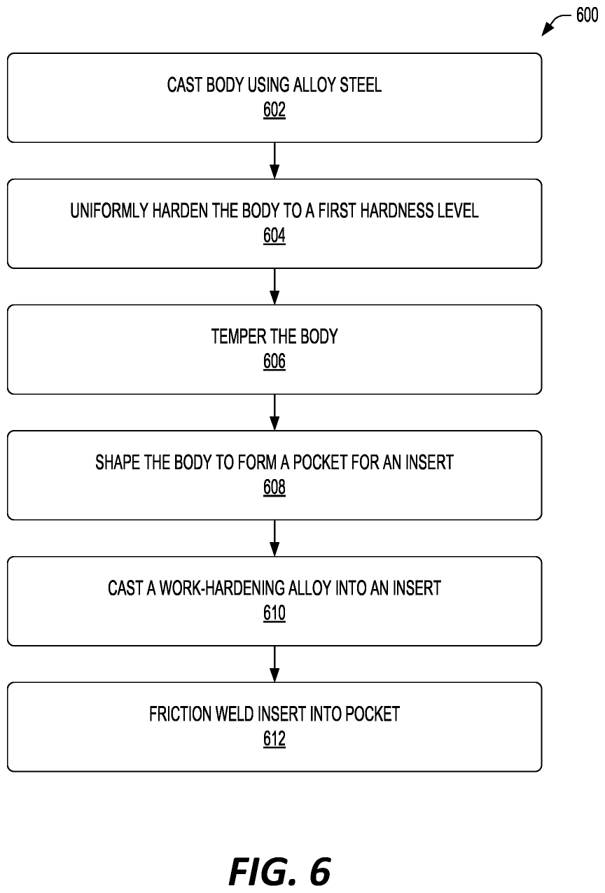

FIG. 6 is a flow diagram depicting an example method 600 for forming the composite track pad described herein, according to at least one example. The track pad 112 described herein may be applicable to any track-type mobile machine. However, the disclosed track pad may be particularly applicable to larger machines, in which the forces passing through the track assembly are significant and can affect longevity of the track pad. This may be particularly important for expensive machines that operate around the clock, where downtime and the price of replacement track pads are costly to the owner.

The method 600 may be performed to produce the track pads described herein for use in track-type machines. At 602, the method 600 includes casting a body using alloy steel. The alloy steel may have sufficient toughness for surviving a harsh environment, such as mining, while also being able to withstand the forces applied through the track pad assembly to support the weight of the track-type machine. For example, the cast body may be formed of a hardenable steel having high toughness and shock resistance. In some examples, the cast body may be formed of a low-carbon alloy steel. In some examples, the cast body may be formed of AISI 4320 alloy steel.

At 604, the method 600 includes uniformly hardening the cast body to a first hardness level. The hardness may be based on the operating environment and/or intended use for the track pad, but may include directly hardening the cast body. The cast body may then be tempered at 606 to reduce brittleness introduced during the hardening process.

At 608, the method 600 includes shaping the cast body (e.g., machining) to form a pocket for an insert. In some examples, multiple different pockets may be formed, such as a first pocket where an insert may be applied to contact roller surfaces of the track assembly. A second pocket may be positioned on drive lugs, and a third pocket may be positioned on a ground-engaging surface of the track pad.

At 610, the method 600 includes casting a work-hardening alloy into an insert shape. The insert shape may be case from a work-hardening alloy such as a manganese-steel, using any suitable casting process known in the art. As used herein, manganese-steel may refer to any suitable type of manganese-steel or manganese-steel alloy for high-strength applications. In some embodiments, chromium may be added to manganese steel before casting in order to increase the rate of work hardening of finished insert. For example, the insert may be cast from manganese steel containing between about 1.0-3.5% chromium. Because the work hardening rate increases as more chromium is added, the insert may be cast from manganese steel containing at least 1.0% chromium in order to reduce in-service plastic deformation of the insert. However, the addition of chromium may be limited to avoid causing carbide embrittlement of the manganese steel. For example, manganese steel containing 14% manganese may include about 1.5% chromium. It is contemplated that manganese steel containing other amounts of chromium may also be used depending on the content of manganese in the steel and the extent to which it is desired to affect the work hardening rate. It is further contemplated that other manganese steel alloys may be used.

The insert may be brittle after casting. Thus, the insert may be solution treated to increase the strength of the metal and reduce brittleness. Solution treating may include raising the temperature of the manganese steel to a high temperature (e.g. about 1000° C.) for about 1-6 hours (depending on the size and thickness of the insert to achieve a fully austenitic grain structure within the manganese steel alloy. Manganese steel having a fully austenitic grain structure is tough, but is considered “soft” and may be further hardened to reduce plastic deformation in the field and resist surface wear during work hardening. However, further heat treatment processes, such as those traditionally used to increase metal hardness, are not desirable for hardening fully austenitic manganese steel because re-heating fully austenitic manganese steel can lead to embrittlement, which can lead to failure of the insert under bearing forces.

In some examples, additional inserts may be cast, similar to the insert described above, for example to be placed on drive lugs and/or ground-engaging surfaces of the track pad, among other locations.

At 612, the method 600 includes friction welding the insert into the pocket. The insert may be linearly friction welded in place such that the connection with the cast body covers an entire surface of the pocket, while also reducing heat introduced to the cast body and/or insert that may affect the strength properties of each. In some examples, additional inserts may also be friction welded in place in a similar process.

It should be noted that some of the operations of method 600 may be performed out of the order presented, with additional elements, and/or without some elements. Some of the operations of method 600 may further take place substantially concurrently and, therefore, may conclude in an order different from the order of operations shown above.

### INDUSTRIAL APPLICABILITY

The present disclosure describes systems, structures, and methods to improve wear tolerance and toughness of components, such as components for track-type machines. These improved components may include track pads used in track chain assemblies of track-based machines. The track pads, as disclosed herein may have an insert made of a work-hardening alloy applied (e.g., through friction welding) to a contact surface of the track pad. The contact surface may be a surface that contacts a roller of the track drive assembly for the track-based machine. The body of the track pad may be formed of an alloy steel having a high level of toughness and strength, while the insert may be formed of a work-hardening alloy, such as manganese-steel, that may be used to specifically address friction and abrasion wearing at the surface that contacts the rollers without requiring the entire track pad to be formed of such a material, which may be expensive and time consuming. Although the track pads and the procedures to form the track pads are discussed in the context of track-type machines and undercarriages of those track-type machines, it should be appreciated that the track pads and the mechanisms to form the same are applicable across a wide array of mechanical systems, such as any mechanical system that can benefit from improved wear resistance of contact surfaces against friction and abrasion in regions of high force transfer.

As a result of the systems, apparatus, and methods described herein, consumable parts of machines, such as track pads may have a greater lifetime. For example, the track pads described herein may have greater service lifetime than traditional track pads that are not formed by the mechanisms described herein. In some cases, the track pads and/or other components may allow for a 25% to 400% improvement in the wear lifetime of consumable parts of track-type machines. This reduces field downtime, reduces the frequency of servicing and maintenance, and overall reduces the cost of heavy equipment, such as track-type machines. The improved reliability and reduced field-level downtime also improves the user experience such that the machine can be devoted to its intended purpose for longer times and for an overall greater percentage of its lifetime. Improved machine uptime and reduced scheduled maintenance may allow for more efficient deployment of resources (e.g., fewer, but more reliable machines at a construction site). Thus, the technologies disclosed herein improve the efficiency of project resources (e.g., construction resources, mining resources, etc.), provide greater uptime of project resources, and improves the financial performance of project resources.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein.

What is claimed is:

1. A track system for track-based machinery, comprising
an undercarriage supporting the track-based machinery:
a sprocket coupled to the undercarriage and driven by a motor;
an idle roller coupled to the undercarriage; and
a set of track pads forming an endless loop around the sprocket and the idle roller, adjacent track pads coupled through bushings, a track pad of the set of track pads comprising:
a body formed of alloy steel having a first surface configured to contact a supporting surface; and
an insert joined with the body at a location opposite the first surface, the insert formed of a work-hardening alloy different from the alloy steel and comprising a roller contact surface configured to interface with the sprocket and the idle roller.

2. The track system of claim 1, wherein the alloy steel comprises a low carbon alloy steel.

3. The track system of claim 1, wherein the alloy steel comprises AISI 4320 steel.

4. The track system of claim 1, wherein the track pad comprises a drive lug positioned on the body, the drive lug configured to interface with the sprocket, and wherein the drive lug comprises a second insert joined with the body at a wear surface of the drive lug, the second insert formed of the work-hardening alloy.

5. The track system of claim 1, wherein the work-hardening alloy comprises a manganese-steel alloy.

6. The track system of claim 5, wherein manganese comprises at least 11% of the manganese-steel alloy.

7. The track system of claim 5, wherein the manganese-steel alloy comprises ASTM A128 steel.

8. The track system of claim 1, wherein the first surface comprises a second insert joined with the body, the second insert formed of a second alloy steel different from the alloy steel.

9. The track system of claim 1, wherein the insert is friction welded with the body.

10. A track pad for track-based machinery, comprising:
a body formed of alloy steel having a first side configured to contact a supporting surface and links adjacent opposite edges for joining to adjacent track pads in a track system; and
an insert joined with the body at a second side opposite the first side, the insert formed of a work-hardening alloy different from the alloy steel and comprising a roller contact surface configured to interface with one or more rollers of the track-based machinery.

11. The track pad of claim 10, wherein the track pad has a length dimension greater than 800 millimeters and a width dimension greater than 300 millimeters.

12. The track pad of claim 10, wherein the insert has a thickness of greater than 75 mm.

13. The track pad of claim 10, wherein the work-hardening alloy comprises an austenitic manganese-steel alloy.

14. The track pad of claim 13, wherein the austenitic manganese-steel alloy comprises ASTM A128 steel.

15. The track pad of claim 10, wherein the alloy steel comprises a low carbon alloy steel.

16. The track pad of claim 10, wherein the alloy steel comprises AISI 4320 steel.

17. The track pad of claim 10, further comprising a drive lug positioned on the body, the drive lug configured to interface with a sprocket of the track system, and wherein the drive lug comprises a second insert joined with the body at a wear surface of the drive lug, the second insert formed of the work-hardening alloy.

18. The track pad of claim 10, wherein the insert is friction welded with the body.

19. A method for forming a track pad, comprising:
casting a body for the track pad using an alloy steel;
causing hardening of the body through a heat treatment and quench process;
shaping the body to form a receiving area;
casting a work-hardening alloy into a roller surface insert; and
joining, by friction welding, the roller surface insert and the receiving area of the body.

20. The method of claim 19, wherein the work-hardening alloy comprises an austenitic manganese-steel alloy.
